(19) United States
(12) Patent Application Publication
(10) Pub. No.: US 2024/0345289 A1
(43) Pub. Date: Oct. 17, 2024

(54) OCEAN-ONTO-LAND DROUGHT (OTLD) IDENTIFICATION AND PROPAGATION MECHANISM ANALYSIS METHOD AND SYSTEM

(71) Applicant: CHINA UNIVERSITY OF GEOSCIENCES (WUHAN), Wuhan (CN)

(72) Inventors: Xihui GU, Wuhan (CN); Yansong GUAN, Wuhan (CN); Lunche WANG, Wuhan (CN); Xiang ZHANG, Wuhan (CN); Yanhui ZHENG, Wuhan (CN); Jie GONG, Wuhan (CN); Dongdong KONG, Wuhan (CN)

(73) Assignee: CHINA UNIVERSITY OF GEOSCIENCES (WUHAN), Wuhan (CN)

(21) Appl. No.: 18/631,075

(22) Filed: Apr. 10, 2024

(30) Foreign Application Priority Data
Apr. 14, 2023 (CN) 202310411090.2

(51) Int. Cl. G01W 1/10; G01W 1/14; G06F 18/2321; G06N 3/02

(52) U.S. Cl. CPC G01W 1/10; G01W 1/14; G06F 18/2321; G06N 3/02; G01W 2201/00

(57) ABSTRACT

An ocean-onto-land drought (OTLD) identification and propagation mechanism analysis method includes: identifying a new drought event in a global range with data of a historical data and data of a future test; extracting a 3D space-time cube (STC) of the drought event, quantifying spatiotemporal characteristics of the global OTLD, and searching a landfalling hotspot; projecting an OTLD in a future period in combination with different tests, and detecting an anthropogenic signal in an index change of the OTLD in the historical period and in the future period; and analyzing, with moisture transport during the OTLD as a reference, an occurrence mechanism of the OTLD in the historical period and an intensification mechanism of the OTLD in the future period; and clarifying a primary physical factor during the OTLD, and assessing a synthetic risk of a OTLD-affected region with a machine learning method.

### CROSS-REFERENCE TO RELATED APPLICATIONS

This application claims priority to Chinese Patent Application No. 202310411090.2 with a filing date of Apr. 14, 2023. The content of the aforementioned application, including any intervening amendments thereto, is incorporated herein by reference.

### TECHNICAL FIELD

The present disclosure relates to the field of atmospheric sciences, and in particular to an ocean-onto-land drought (OTLD) identification and propagation mechanism analysis method and system.

### BACKGROUND

As the most serious meteorological disasters in the world, droughts are posing a threat to agricultural security and social development of various countries. Particularly for extreme drought events with a high intensity and a long duration, the resulting serious water shortage inhibits human activities. Moisture (precipitation-minus-evapotranspiration (PME)) deficits have migrated from ocean onto land to form a new type of droughts. Compared with land-only droughts, the newly identified OTLDs are more intense (+4-30%), more widespread (+220-425%), and faster (+253-285%).

At present, there have been neither concerns of academic circles on whether OTLDs are affected by anthropogenic climate changes, nor meticulous studies on a propagation mechanism of the OTLDs.

### SUMMARY OF PRESENT INVENTION

In order to solve the problem of no meticulous studies on a propagation mechanism of OTLDs at present, the present disclosure provides an OTLD identification and propagation mechanism analysis method and system. By quantifying anthropogenic impacts on spatiotemporal changes in OTLDs, analyzing a propagation mechanism of OTLD-related moisture deficits, and assessing a synthetic risk of OTLD-affected regions, the present disclosure provides powerful scientific bases for disaster prevention and reduction in coastal drought-prone regions, and greatly improves a reliability of drought control measures in the drought-prone regions.

The present disclosure provides an OTLD identification and propagation mechanism analysis method, specifically including the following steps:
step S1, data acquisition: acquiring data including precipitation, evapotranspiration, meridional wind velocity, zonal wind velocity, specific humidity, and surface air pressure in the Coupled Model Intercomparison Project Phase 6 (CMIP6); and acquiring a mask file for global land;
step S2, OTLD identification: calculating, with a kernel density estimate, the data in the step S1, and a PME, a drought index for characterizing an atmospheric drought, setting a drought threshold to divide a grid cell in a drought state, obtaining a space-time cube (STC) of the drought through three-dimensional (3D) spatiotemporal clustering, setting a drought landfalling area threshold, and extracting an STC of an OTLD in combination with the mask file in the step S1;
step S3, OTLD spatiotemporal characteristic quantification: calculating a temporal characteristic, a spatial characteristic and an intensity characteristic of the OTLD in combination with the STC of the OTLD in the step S2, and mapping the temporal characteristic, the spatial characteristic and the intensity characteristic to a spatial grid cell to obtain a grid cell index;
step S4, OTLD index detection and attribution: dividing spatiotemporal characteristics of the OTLD in the step S3 into an event index and the grid cell index, performing detection and attribution on an event index and a grid cell index of the OTLD in a historical forcing test and a natural forcing test, and performing detection and attribution on a grid cell index of the OTLD in the historical forcing test and a future shared socio-economic pathway (SSP) scenario test;
step S5, analysis of an occurrence mechanism in a historical period and an intensification mechanism in a future period for the OTLD: establishing a physical moisture transport model in combination with the 3D STC of the OTLD in the step 3, analyzing a moisture transport condition in a pre-landfalling period and a moisture transport condition in a post-landfalling period, analyzing the occurrence mechanism and the intensification mechanism of the OTLD, and acquiring a primary physical factor of the OTLD; and
step S6, OTLD synthetic risk assessment: performing risk assessment on an OTLD-affected land region in combination with the grid cell index of the OTLD in the step S3, and a neural network model.

The present disclosure has following beneficial effects:
(1) The present disclosure provides the OTLD identification method to facilitate better understanding of academic circles on the new type of droughts. The present disclosure quantifies an event index and a spatial grid mapping index of the OTLD, and clarifies changes and impacts of the OTLD in time and space. The present disclosure conducts synthetic risk assessment on OTLD-affected regions with a machine learning method, and classifies different risk levels for different OTLD-affected regions, thereby providing scientific bases for drought adaptation measures.
(2) The present disclosure performs quantitative detection on the index of the OTLD, identifies anthropogenic impacts on the OTLD in different regions, and projects a future change of the OTLD. This provides a theoretical support for decision makers to formulate climate change adapting and relieving decisions on the OTLD.
(3) The present disclosure analyzes moisture transport conditions of the OTLD, and clarifies a physical mechanism for generating the OTLD in a historical period and a physical mechanism for enhancing the OTLD in a future period in different regions. Based on quantization of the physical moisture transport process, the present disclosure clarifies a primary physical factor in the future OTLD intensification from a dynamic factor and a thermodynamic factor. This provides a theoretical support for attribution of the OTLD.

### BRIEF DESCRIPTION OF THE DRAWINGS

FIG. 1 illustrates a flowchart of an OTLD identification and propagation mechanism analysis method according to the present disclosure;

FIG. 2 illustrates origination, propagation and landfalling of an OTLD;

FIG. 3 illustrates detection and attribution on an event index and a spatial grid mapping index of an OTLD in a historical period;

FIG. 4 illustrates detection and attribution on a spatial grid mapping index of an OTLD in a future period and prediction on an event index of the OTLD in the future period;

FIG. 5 illustrates an anomaly of a moisture flux divergence in occurrence and intensification of an OTLD of a landfalling hotspot in a historical period and a future period;

FIG. 6 illustrates a propagation mechanism and synthetic risk assessment of OTLDs;

FIG. 7 illustrates occurrence and intensification of an OTLD over the North America in a historical period and a future period;

FIG. 8 illustrates an anomaly of a moisture flux divergence and an anomaly of a PME in occurrence and intensification of an OTLD over the North America in a historical period and a future period; and

FIG. 9 illustrates contribution of a primary physical factor in intensification of an OTLD in a future period.

### DETAILED DESCRIPTION OF THE EMBODIMENTS

In order to make the objective, technical solution and advantages of the present disclosure clearer, embodiments of the present disclosure will be further described in detail in conjunction with the accompanying drawings.

The present disclosure provides an OTLD identification and propagation mechanism analysis method, specifically including the following steps:

In step S1, data acquisition is performed. Data including precipitation, evapotranspiration, meridional wind velocity, zonal wind velocity, specific humidity, and surface air pressure in the CMIP6 is acquired. A mask file for global land is acquired.

In step S2, OTLD identification is performed. With a kernel density estimate, the data in the step S1, and a PME, a drought index for characterizing an atmospheric drought is calculated. A drought threshold is set to divide a grid cell in a drought state. An STC of the drought is obtained through 3D spatiotemporal clustering. A drought landfalling area threshold is set. An STC of an OTLD is extracted in combination with the mask file in the step S1.

In step S2, with a PME of each pattern in the historical forcing test, the natural forcing test and the future SSP scenario test, the drought index is calculated through the kernel density estimate. Specifically:

SPMEIₜ=\hat{F}(PMEₜ)

In the foregoing Eq., SPMEI is the drought index, t is a month, \hat{F} is an empirical distribution function obtained through the kernel density estimate, and PME is the precipitation-minus-evapotranspiration.

For the drought index in the natural forcing test and the future SSP scenario test, the empirical distribution function obtained through the kernel density estimate with data in the historical forcing test is used, so as to ensure a climatological stability. In the present disclosure, the kernel density estimate is obtained with a Gaussian kernel function.

Two-dimensional (2D) median filtering is performed on spatial grid data of the drought at each timestep. Threshold division is performed. A drought threshold is set. The spatial grid data is converted into binary grid data of 1 (a drought) and 0 (a non-drought). In the present disclosure, the drought threshold is defined as 0.2.

The 3D STC of the drought is identified with the 3D spatiotemporal clustering algorithm. In the algorithm, at each timestep, all cells of 1 and adjacent cells of 1 are merged into one drought event. In timesteps of continuous drought events, a minimum overlapping area is set, and adjacent time events with an overlapping area beyond the threshold are merged into one 3D event. In the present disclosure, the minimum overlapping area is set as 10,000 km².

A minimum landfalling area is set with the land mask file in the step S1. A 3D drought event originated from ocean with a landfalling area beyond the threshold is identified as the OTLD. Considering that the OTLD is originated from the ocean and migrated onto the land, drought events with the duration greater than two months are selected to screen out the OTLD. The OTLD is defined as the 3D drought event, which is completely originated from the ocean and migrated onto the land with the landfalling area beyond the threshold. In the present disclosure, the minimum landfalling area is set as 100,000 km².

In step S3, OTLD spatiotemporal characteristic quantification is performed. A temporal characteristic, a spatial characteristic and an intensity characteristic of the OTLD are calculated in combination with the STC of the OTLD in the step S2, and mapped to a spatial grid cell to obtain a grid cell index.

In step S3, the temporal characteristic, the spatial characteristic and the intensity characteristic of the OTLD are respectively a duration, a maximum area, and an intensity and the synthetic index. The duration refers to lifetime of the OTLD. The maximum area refers to a total area of spatial grid cells affected by the OTLD. The intensity refers to a sum of a PME corresponding to each grid cell in the 3D STC of the OTLD. Specifically:

$$Synthetic index = {\sum }_{t ∈ T} {\sum }_{i ∈ {A}_{t}} \frac{P M {E}_{i , t} \times {S}_{i}}{{\sum }_{i ∈ A} {S}_{i}}$$

In the foregoing Eq., t is time, T is a time range, i is the grid cell, A is a spatial range of the OTLD in the timestep, PME is the precipitation-minus-evapotranspiration, and S is an area of the grid cell.

The spatially mapped grid cell index of the OTLD is quantified as a frequency, the duration, an area, the intensity, and the synthetic index. Specifically:

$${Frequency}_{k} = {\sum }_{j ∈ N} 1 ,$$

$${Duration}_{k} = {\sum }_{j ∈ N} {\sum }_{{t}_{j} ∈ {T}_{j}} 1 ,$$

$${Area}_{k} = {\sum }_{j ∈ N} {\sum }_{{t}_{j} ∈ {T}_{j}} {\sum }_{{i}_{j , t} ∈ {A}_{j , t}} {S}_{i}$$

$${Intensity}_{k} = {\sum }_{j ∈ N} {\sum }_{{t}_{j} ∈ {T}_{j}} {\sum }_{{i}_{j , t} ∈ {A}_{j , t}} P M {E}_{i , t} ,$$

$$Synthetic {index}_{k} = {\sum }_{j ∈ N} {\sum }_{{t}_{j} ∈ {T}_{j}} {\sum }_{{i}_{j , t} ∈ {A}_{j , t}} Synthetic {index}_{i , t}$$

In the foregoing Eq., k is the corresponding grid cell, t is the time, T is the time range, j is the OTLD, N is an OTLD assemble, i is the grid cell of the OTLD, A is the spatial range of the drought in the timestep, PME is the precipitation-minus-evapotranspiration, and S is the area of the grid cell.

In step S4, OTLD index detection and attribution are performed. Spatiotemporal characteristics of the OTLD in the step S3 are divided into an event index and a grid cell index. Detection and attribution are performed on an event index and a grid cell index of the OTLD in a historical forcing test and a natural forcing test. Detection and attribution are performed on a grid cell index of the OTLD in the historical forcing test and a future SSP scenario test.

In step S4, a landfalling hotspot is identified. An extreme OTLD in each pattern of the historical forcing test and the natural forcing test is selected. A landfalling frequency of the extreme OTLD in each pattern in the spatial grid cell is calculated. A landfalling-prone region is divided. The extreme OTLD in the present disclosure is defined as an OTLD with a top-100 synthetic index.

Detection and attribution are performed on the event index of the OTLD. A duration, a maximum area, an intensity, and a synthetic index of the extreme OTLD in each pattern are synthesized into an event index sequence. A Kolmogorov-Smirnov (K-S) test is performed. A probability distribution difference in the event index sequence of the OTLD between the two tests is clarified.

Detection and attribution are performed on the grid cell index mapped by the OTLD. A frequency, the duration, an area, the intensity, and the synthetic index mapped by the extreme OTLD in each pattern to the spatial grid cell are accumulated in time scale. A number of years in a whole time period is divided to obtain an annual average grid cell index of the OTLD. A ratio of a difference between an annual average grid cell index in the historical forcing test and an annual average grid cell index in the natural forcing test to the annual average grid cell index in the historical forcing test (a ratio of a difference between an annual average grid cell index in the future SSP scenario test and the annual average grid cell index in the historical forcing test to the annual average grid cell index in the future SSP scenario test) is defined as an anomaly percent for the grid cell index of the OTLD in the historical period and the future period

A spatial grid cell in the landfalling-prone region is selected. Area-weighted averaging is performed. A relative anthropogenic index (RAI) in each pattern is calculated. Specifically:

$$R A I = \frac{{\sum }_{i ∈ A} index\_anomaly \_percent \times {S}_{i}}{{\sum }_{i ∈ A} {S}_{i}}$$

In the foregoing Eq., i is the grid cell, A is a range of a studied region, S is an area of the grid cell, and index_anomaly_percent is the anomaly percent for the grid cell index of the OTLD.

Further, sampling is performed 10,000 times on a RAI of a multi-model ensemble with a bootstrapping method to calculate 95% confidence intervals (CIs), thereby detecting an anthropogenic signal.

In step S5, an occurrence mechanism in a historical period and an intensification mechanism in a future period for the OTLD are analyzed. A physical moisture transport model is established in combination with the 3D STC of the OTLD in the step 3. A moisture transport condition in a pre-landfalling period and a moisture transport condition in a post-landfalling period are analyzed. The occurrence mechanism and the intensification mechanism of the OTLD are analyzed. A primary physical factor of the OTLD is acquired.

In step S5, the physical moisture transport model is established in combination with an initial dataset. The moisture transport condition in the pre-landfalling period and the moisture transport condition in the post-landfalling period are analyzed.

The physical moisture transport model is established by:

$$\vec{Q} = \frac{1}{g} \vec{V} q$$

$$∇ \cdot \vec{Q} = ∇ \cdot ( \frac{1}{g} \vec{V} q ) = \frac{\partial }{\partial x} ( \frac{1}{g} uq ) + \frac{\partial }{\partial y} ( \frac{1}{g} vq )$$

In the foregoing Eq., \vec{V} is (u,v), u is zonal wind, v is meridional wind, q is a specific humidity, \vec{Q} is a moisture flux, x and y are respectively a meridional distance and a zonal distance, ∇ is a divergence operator, and g is a gravitational acceleration.

With the moisture transport condition in the pre-landfalling period and the moisture transport condition in the post-landfalling period, the occurrence mechanism and the intensification mechanism of the OTLD are further analyzed. In the present disclosure, the pre-landfalling period is defined as origination of the OTLD from the ocean to a timestep before migration onto the land, and the post-landfalling period is defined as migration of the OTLD onto the land to an area of less than 100,000 km².

Multidimensional construction is performed on a physical model from a physical factor. The physical factor is decomposed into an advection dynamic component, an advection thermodynamic component, a convergence dynamic component, a convergence thermodynamic component, and a nonlinear component. Specifically:

$$δ ( {\int }_{pt}^{ps} ∇ \cdot ( \overline{q} \overline{\vec{V}} ) dp ) = {\int }_{pt}^{ps} {\overline{\vec{V}}}_{c} ∇ {\overline{q}}_{a} dp + {\int }_{pt}^{ps} {\overline{q}}_{a} ∇ \cdot {\overline{\vec{V}}}_{c} dp + {\int }_{pt}^{ps} {\overline{\vec{V}}}_{a} ∇ {\overline{q}}_{c} dp + {\int }_{pt}^{ps} {\overline{q}}_{c} ∇ \cdot {\overline{\vec{V}}}_{a} dp + {\int }_{pt}^{ps} ∇ \cdot ( {\overline{q}}_{a} {\overline{\vec{V}}}_{a} ) dp$$

In the foregoing Eq., q̅ and \overline{\vec{V}} respectively represent a monthly average specific humidity and a monthly average wind velocity, q̅_{c} and \overline{\vec{V}}_{c} are respectively a specific humidity and a wind velocity in a reference period of the historical forcing test (a pre-landfalling/post-landfalling period of the OTLD in the historical forcing test), q̅ₐ and \overline{\vec{V}}ₐ respectively represent a difference of an average specific humidity and a difference of an average wind velocity in the pre-landfalling/post-landfalling period of the OTLD in the historical forcing test as compared to the reference period of the historical forcing test (in a pre-landfalling/post-landfalling period of the OTLD in the future SSP scenario test as compared to the OTLD in the historical forcing test), ps is a surface air pressure, pt is a pressure at a top of an atmosphere, δ is a deviation operator, ∇ is the divergence operator, d is an integral element, and p is an atmospheric pressure.

In step S6, OTLD synthetic risk assessment is performed. Risk assessment is performed on an OTLD-affected land region in combination with the grid cell index of the OTLD in the step S3, and a neural network model.

In step S6, based on the grid cell index of the extreme OTLD in each pattern, including the frequency, the duration, the area, and the intensity, unsupervised clustering is performed with a self-organizing map (SOM) neural network to obtain synthetic risks of different grid cells. In the present disclosure, data to be trained in the SOM neural network is an anomaly percent of an average grid cell index of the extreme OTLD in the assemble in the historical forcing test and the future SSP scenario test.

As an implementation, the present disclosure is further described with global OTLDs in 1961-2020 as an example. The implementation is intended to illustrate the present disclosure, rather than limit an application scope of the present disclosure. The implementation is also applied to other regions and other time periods.

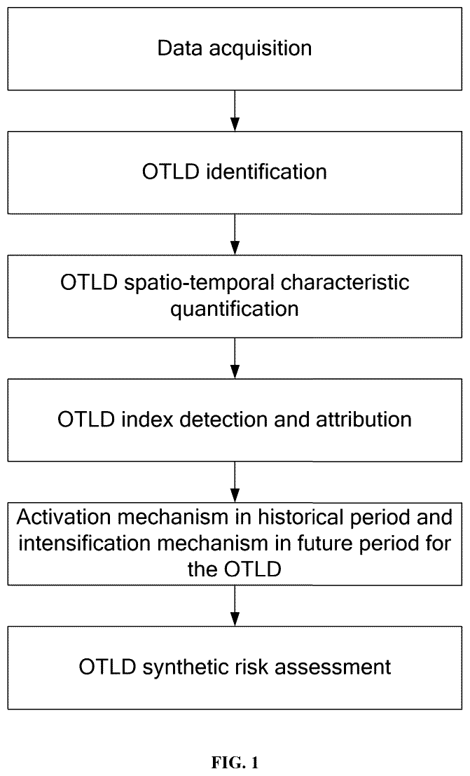

In present disclosure, as shown in FIG. 1, an implementation flowchart for an OTLD identification and propagation mechanism analysis method specifically includes the following steps:

(1) Test data acquisition is performed.

In the implementation, 10 pieces of test data in CMIP6 are acquired. Test scenarios include a historical forcing test, a natural forcing test, and a future SSP scenario test. The test data includes ACCESS-CM2, ACCESS-ESM1-5, BCC-CSM2-MR, CanESM5, FGOALS-g3, GFDL-ESM4, IPSL-CM6A-LR, MIROC6, MRI-ESM2-0 and NorESM2-LM. Precipitation, evapotranspiration, meridional wind velocity, zonal wind velocity, specific humidity, and surface air pressure serve as variables. Atime series covers a period of 1961-2020 and a period of 2021-2100. Meteorological data is interpolated with a bilinear interpolation method, with a spatial resolution being 1°×1°.

(2) OTLD identification is performed.

In the implementation, within the global range, the historical forcing test and the future SSP scenario test are spliced in time scale to obtain meteorological data from 1961 to 2100. For data of the historical forcing test from 1961 to 2020, a drought index is calculated with a PME and a kernel density estimate. Specifically:

SPMEIₜ=\hat{F}(PMEₜ)

In the foregoing Eq., SPMEI is the drought index, t is a month, \hat{F} is an empirical distribution function obtained through the kernel density estimate, and PME is the precipitation-minus-evapotranspiration.

Further, an empirical distribution function for the data of the historical forcing test from 1961 to 2020 is used for the spliced data of the historical forcing test and the future SSP scenario test, and the data of the natural forcing test from 1961 to 2100, thereby calculating the drought index. 2D median filtering is performed on spatial grid data of the drought at each timestep. Threshold division is performed. A drought threshold is set. The spatial grid data is converted into binary grid data of 1 (a drought) and 0 (a non-drought). In the implementation, the drought threshold is defined as 0.2.

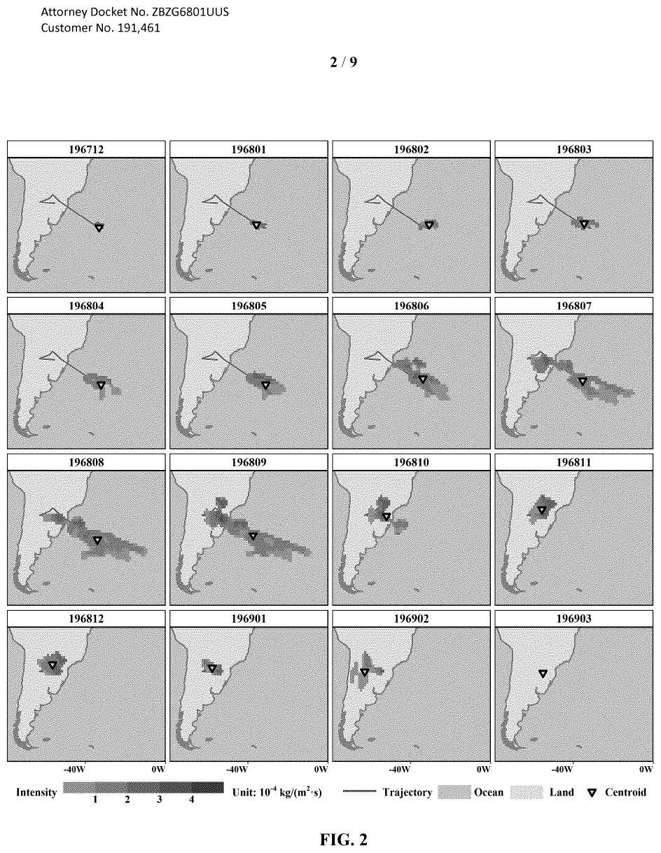

A 3D STC of the drought is identified with a 3D spatiotemporal clustering algorithm. A minimum landfalling area is set. A 3D drought event originated from ocean with a landfalling area beyond the threshold is identified as an OTLD. FIG. 2 shows origination, propagation and landfalling of a typical OTLD. In the implementation, the minimum overlapping area is set as 10,000 km², and the minimum landfalling area is set as 100,000 km².

(3) OTLD spatiotemporal characteristic quantification is performed.

In the implementation, characteristics of a 3D STC of the OTLD in the historical forcing test, the natural forcing test and the future SSP scenario test obtained with the 10 pieces of test data in the CMIP6 are quantified. A temporal characteristic, a spatial characteristic and an intensity characteristic of the OTLD are respectively a duration, a maximum area, and an intensity and a synthetic index. The duration refers to lifetime of the OTLD. The maximum area refers to a total area of spatial grid cells affected by the OTLD. The intensity refers to a sum of a PME corresponding to each grid cell in the 3D STC of the OTLD. Specifically:

$$Synthetic index = {\sum }_{t ∈ T} {\sum }_{i ∈ {A}_{t}} \frac{{PME}_{i , t} \times {S}_{i}}{{\sum }_{i ∈ A} {S}_{i}}$$

In the foregoing Eq., t is time, T is the time range, i is the grid cell, A is a spatial range of the OTLD in the timestep, PME is the precipitation-minus-evapotranspiration, and S is an area of the grid cell.

The spatially mapped grid cell index of the OTLD is quantified as a frequency, the duration, an area, the intensity, and the synthetic index. Specifically:

$${Frequency}_{k} = {\sum }_{j ∈ N} 1 ,$$

$${Duration}_{k} = {\sum }_{j ∈ N} {\sum }_{{t}_{j} ∈ {T}_{j}} 1 ,$$

$${Area}_{k} = {\sum }_{j ∈ N} {\sum }_{{t}_{j} ∈ {T}_{j}} {\sum }_{{i}_{j , t} ∈ {A}_{j , t}} {S}_{i}$$

$${Intensity}_{k} = {\sum }_{j ∈ N} {\sum }_{{t}_{j} ∈ {T}_{j}} {\sum }_{{i}_{j , t} ∈ {A}_{j , t}} {PME}_{i , t} ,$$

$$Synthetic {index}_{k} = {\sum }_{j ∈ N} {\sum }_{{t}_{j} ∈ {T}_{j}} {\sum }_{{i}_{j , t} ∈ {A}_{j , t}} {PME}_{i , t} {S}_{i}$$

In the foregoing Eq., k is the corresponding grid cell, t is the time, T is the time range, j is the OTLD, N is an OTLD assemble, i is the grid cell of the OTLD, A is the spatial range of the drought in the timestep, PME is the precipitation-minus-evapotranspiration, and S is the area of the grid cell.

(4) OTLD index detection and attribution are performed.

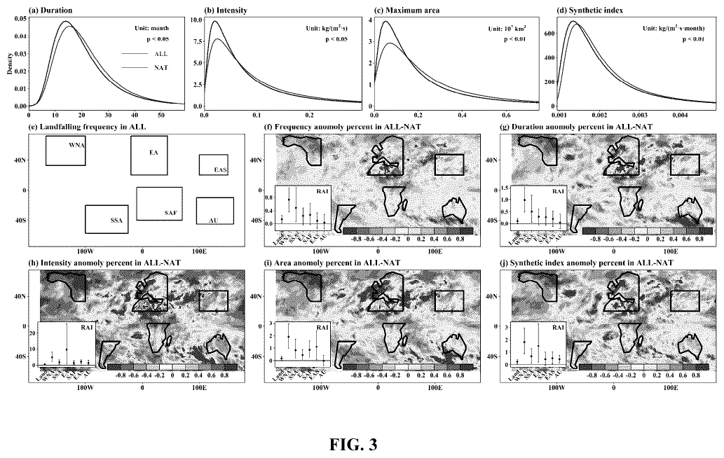

In the implementation, with an event index and a grid cell index for the spatiotemporal characteristics of the OTLD, an extreme OTLD is screened out. A duration, a maximum area, an intensity, and a synthetic index of each extreme OTLD in the ten piece of test data in the CMIP6 are synthesized into a sequence, thereby obtaining a sequence for the duration, the maximum area, the intensity, and the synthetic index of the extreme OTLD in the historical forcing test and the natural forcing test. A probability density curve is fitted (as shown in FIG. 3a-d). In the implementation, the extreme OTLD is defined as an OTLD with a top-100 synthetic index. A K-S test is performed to obtain a distribution difference in the event index sequence of the OTLD between the two tests. The p value is less than 0.05 (as shown in FIG. 3a-d). There is a significant difference between the two tests in a probability density distribution for the event index sequence of the OTLD. Compared with the natural forcing test, the historical forcing test dominated by anthropogenic impacts has a larger probability with a larger index and a more extreme condition. Therefore, it can be considered that the anthropogenic impacts increase the event index of the OTLD.

A landfalling frequency of the extreme OTLD in each pattern of the historical forcing test in the spatial grid cell is calculated. A landfalling-prone region is divided. As shown in FIG. 3e, there are such OTLD landfalling-prone continental coastal regions as western North America (WNA), southern South America (SSA), Europe and northern Africa (EA), southern Africa (SAF), eastern Asia (EAS), and Australia (AU).

The frequency, the duration, the area, the intensity, and the synthetic index of the extreme OTLD in each pattern mapped to the spatial grid cell are accumulated in time scale. A number of years in a whole time period is divided to obtain an annual average grid cell index of the OTLD. A ratio of a difference between an annual average grid cell index in the historical forcing test and an annual average grid cell index in the natural forcing test to the annual average grid cell index in the historical forcing test is defined as an anomaly percent for the grid cell index of the OTLD in the historical period (FIG. 3f-j). In the WNA, the five spatial mapping indexes spatially show a positive anomaly percent, indicating that the anthropogenic impacts intensify the extreme OTLD in the regions of the WNA. In the SSA, the five spatial mapping indexes spatially show a positive anomaly percent in most regions of the SSA, indicating that the anthropogenic impacts intensify the extreme OTLD in the regions of the SSA. In the EA, the five spatial mapping indexes spatially show a negative anomaly percent in most European regions of the EA, the frequency, the duration and the synthetic index are negative in most African regions of the EA, and the intensity and the area are positive in most African regions of the EA. This indicates that the anthropogenic impacts inhibit the extreme OTLD in the regions of the EA. In the SAF, the frequency, the duration, and the synthetic index are negative in the middle of the SAF and positive in other regions, and the intensity and the area are positive in most regions of the SAF. This indicates that the anthropogenic impacts intensify the extreme OTLD in the regions of the EA. In the EAS, the five spatial mapping indexes spatially show a positive anomaly percent in most European regions of the EA, indicating that the anthropogenic impacts intensify the extreme OTLD in the regions of the EAS. In the AU, the frequency, the duration, and the area are negative in the southwest of the AU and positive in rest regions of the AU, and the intensity and the synthetic index are positive in most regions of the SAF. This indicates that the anthropogenic impacts intensify the extreme OTLD in the regions of the AU.

Through further calculation, anthropogenic impacts on the OTLD in the global land and the landfalling hotspot are quantified with the RAI. A spatial grid cell in the landfalling-prone region is selected. Area-weighted averaging is performed. The RAI in each pattern is calculated. Specifically:

$$RAI = \frac{{\sum }_{i ∈ A} index\_anomaly \_percent \times {S}_{i}}{{Σ}_{i ∈ A} {S}_{i}}$$

In the foregoing Eq., i is the grid cell, A is a range of a studied region, S is an area of the grid cell, and index_anomaly_percent is the anomaly percent for the grid cell index of the OTLD. Further, sampling is performed 10,000 times on a RAI of a multi-model ensemble with a bootstrapping method to calculate 95% CIs, thereby detecting an anthropogenic signal. As shown by RAI in FIG. 3f-j, for the global land, the WNA, and the SSA, the five spatial mapping indexes are greater than zero in 95% CIs, and the anthropogenic signal is detachable. In terms of the duration, the anthropogenic signal is undetectable in the EA, the SAF, the EAS and the AU. In terms of the intensity, the anthropogenic signal is detachable in the EA, the SAF, the EAS and the AU. In terms of the area, the anthropogenic signal is detachable in the EA, the SAF and the EAS, and undetectable in the AU. In the synthetic index, the anthropogenic signal is detachable in the EA, the EAS, and the AU, and undetectable in the SAF.

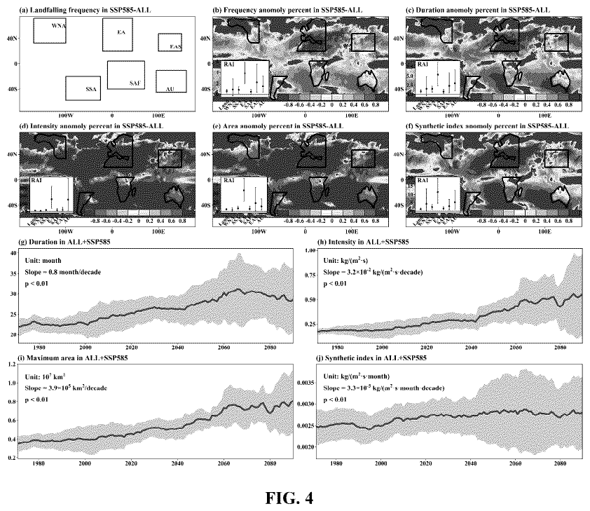

A difference in landfalling frequency of the extreme OTLD in each pattern of the future SSP scenario test and the historical forcing test in the spatial grid cell is calculated. As shown in FIG. 4a, the extreme OTLD is still frequent in the six landfalling hotspots in the future period.

A ratio of a difference between the annual average grid cell index of the OTLD in the future SSP scenario test and the annual average grid cell index of the OTLD in the historical forcing test to the annual average grid cell index of the OTLD in the future SSP scenario test is defined as an anomaly percent for the grid cell index of the OTLD in the future period (as shown in FIG. 4b-f). In the WNA, the five spatial mapping indexes spatially show a positive anomaly percent in the south of the WNA, and a negative anomaly percent in the north, indicating that the anthropogenic impacts intensify the extreme OTLD in the south of the WNA, and inhibit the impacts on the north of the WNA in the future. In the SSA, the five spatial mapping indexes spatially show a positive anomaly percent in most regions of the SSA, and the frequency, the duration, and the synthetic index are negative in a part of the east, indicating that the anthropogenic impacts intensify the extreme OTLD in the regions of the SSA in the future. In the EA, the five spatial mapping indexes spatially show a positive anomaly percent in most regions of the EA, and a negative anomaly percent in the north of the EA. This indicates that the anthropogenic impacts intensify the extreme OTLD in the regions of the EA in the future. In the SAF, the five spatial mapping indexes spatially show a positive anomaly percent in most regions of the SAF, and the frequency, the duration, and the synthetic index are negative in the north of the SAF. This indicates the anthropogenic impacts intensify the extreme OTLD in the regions of the SAF in the future. In the EAS, the five spatial mapping indexes spatially show a positive anomaly percent in most European regions of the EA, indicating that the anthropogenic impacts intensify the extreme OTLD in the regions of the EAS in the future. In the AU, the five spatial mapping indexes spatially show a positive anomaly percent in most regions of the AU, and the frequency, the duration, and the synthetic index are negative in the south of the AU. This indicates that the anthropogenic impacts intensify the extreme OTLD in the regions of the AU in the future.

The RAI is calculated to quantify anthropogenic impacts on the extreme OTLD in the global land and the landfalling hotspots in the future period. As shown by the RAI in FIG. 4b-f, the five spatial mapping indexes of the global land surface, the SSA, the EA, the SAF, and the AU are greater than zero in 95% CIs, and the anthropogenic signal can be detachable. In the WNA, the anthropogenic signal can be detachable in terms of the area, and undetectable in terms of the frequency, the duration, the intensity, and the synthetic index.

Years with the extreme OTLD in the future SSP scenario test and the historical forcing test are counted. A 30-year sliding window is used to obtain the extreme OTLD in each year, as shown in FIG. 4g-j. In the future SSP scenario test, the extreme OTLD is significantly increased in duration, the maximum area, the intensity, and the synthetic index.

(5) An occurrence mechanism in a historical period and an intensification mechanism in a future period for the OTLD are analyzed.

A physical moisture transport model is established. A moisture transport condition in a pre-landfalling period and a moisture transport condition in a post-landfalling period are analyzed.

The physical moisture transport model is established by:

$$\vec{Q} = \frac{1}{g} \vec{V} q$$

$$∇ \cdot \vec{Q} = ∇ \cdot ( \frac{1}{g} \vec{V} q ) = \frac{\partial }{\partial x} ( \frac{1}{g} uq ) + \frac{\partial }{\partial y} ( \frac{1}{g} vq )$$

In the foregoing Eq., \vec{V} is (u,v), u is a zonal wind, v is a meridional wind, q is a specific humidity, \vec{Q} is a moisture flux, x and y are respectively a meridional distance and a zonal distance, ∇ is a divergence operator, and g is a gravitational acceleration.

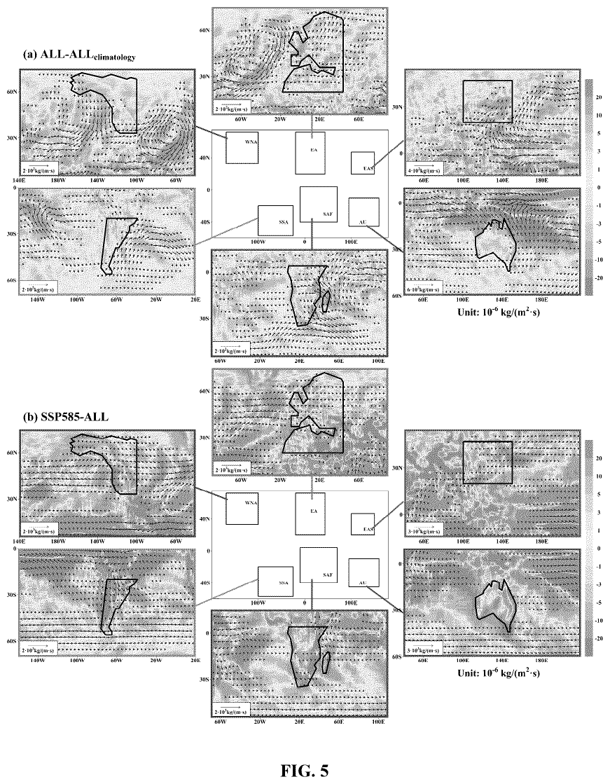

With the moisture transport condition in the pre-landfalling period and the moisture transport condition in the post-landfalling period, the occurrence mechanism and the intensification mechanism of the OTLD are further analyzed. In the present disclosure, the pre-landfalling period is defined as origination of the OTLD from the ocean to a timestep before migration onto the land, and the post-landfalling period is defined as migration of the OTLD onto the land to an area of less than 100,000 km². For the OTLD, the moisture transport occurrence condition depends on a difference between average time of the OTLD in the historical forcing test and an average time in a reference period of the historical forcing test, and the moisture transport enhancement condition depends on a difference between average time of the OELD event in the future SSP scenario test and the average time of the OTLD in the historical forcing test. The moisture transport conditions of six landfalling hotspots in the post-landfalling period are obtained, as shown in FIG. 5.

As shown in FIG. 5(a), in the WNA, under the Azores High and Hawaiian High, moisture in the WNA is transported to the ocean through subtropical Pacific north wind. In the SSA, for moisture convergence caused by cyclones in the south Atlantic, moisture in the SSA is transported to the eastern ocean. In the EA, due to anticyclones in the mid-latitude Atlantic and the EA, moisture in the EA flows out to cause moisture deficits of the Atlantic. This does not facilitate transportation of the moisture to the EA. In the SAF, anticyclones in the east of the SAF facilitate moisture divergence. In the EAS, under the West Pacific Subtropical High (WPSH) and the trade wind, moisture in the northwest Pacific and the EAS is reduced. In the AU, cyclones in the east of the AU carry moisture from the AU and the Pacific toward the equatorial convergence zone.

As shown in FIG. 5(b), in the WNA, due to the enhanced subtropical high pressure, the moisture is transported eastward. The moisture flows to the north of the WNA to decrease the OTLD in the north of the WNA, and increase the OTLD in the south of the WNA. In the SSA, due to enhanced anticyclones in eastern coastal regions of the SSA, more moisture in the SSA flows out, thereby increasing the OTLD in the whole SSA. Due to increased moisture in the east of the SSA, the OTLD in the east of the SSA is decreased. In the EA, due to the enhanced subtropical high pressure, the moisture is less transported to the EA to increase the OTLD. The whole moisture is transported to the north Europe with a poleward shift, such that the North Europe is filled with the moisture to dramatically decrease the OTLD in the north Europe. In the SAF, the trade wind in the northeast of the SAF is enhanced, such that the moisture in the SAF and the Indian Ocean is lost to increase the OTLD in the SAF. In the EAS, due to the enhanced WPSH, the moisture divergence region covers the coastal regions of the EAS to increase the OTLD in the EAS. In the AU, due to the expanded intertropical convergence zone (ITCZ), the moisture flux in the AU changes little. Under moisture deficits in the South Atlantic, the AU is located in the moisture divergence region, such that the moisture in the AU is lost to increase the OTLD.

Multidimensional construction is performed on a physical model from a physical factor. The physical factor is decomposed into an advection dynamic component, an advection thermodynamic component, a convergence dynamic component, a convergence thermodynamic component, and a nonlinear component. Specifically:

$$δ ( {\int }_{pt}^{ps} ∇ \cdot ( \overline{q} \overline{\vec{V}} ) dp ) \approx {\int }_{pt}^{ps} {\overline{\vec{V}}}_{c} ∇ {\overline{q}}_{a} dp + {\int }_{pt}^{ps} {\overline{q}}_{a} ∇ \cdot {\overline{\vec{V}}}_{c} dp + {\int }_{pt}^{ps} {\overline{\vec{V}}}_{a} ∇ {\overline{q}}_{c} dp + {\int }_{pt}^{ps} {\overline{q}}_{c} ∇ \cdot {\overline{\vec{V}}}_{a} dp + {\int }_{pt}^{ps} ∇ \cdot ( {\overline{q}}_{a} {\overline{\vec{V}}}_{a} ) dp$$

In the foregoing Eq., q̅ and \overline{\vec{V}} respectively represent a monthly average specific humidity and a monthly average wind velocity, q̅_{c} and \overline{\vec{V}}_{c} are respectively a specific humidity and a wind velocity in a reference period of the historical forcing test (a pre-landfalling/post-landfalling period of the OTLD in the historical forcing test), q̅ₐ and \overline{\vec{V}}ₐ respectively represent a difference of an average specific humidity and a difference of an average wind velocity in the pre-landfalling/post-landfalling period of the OTLD in the historical forcing test as compared to the reference period of the historical forcing test (in a pre-landfalling/post-landfalling period of the OTLD in the future SSP scenario test as compared to the OTLD in the historical forcing test), ps is a surface air pressure, pt is a pressure at a top of an atmosphere, δ is a deviation operator, ∇ is the divergence operator, d is an integral element, and p is an atmospheric pressure.

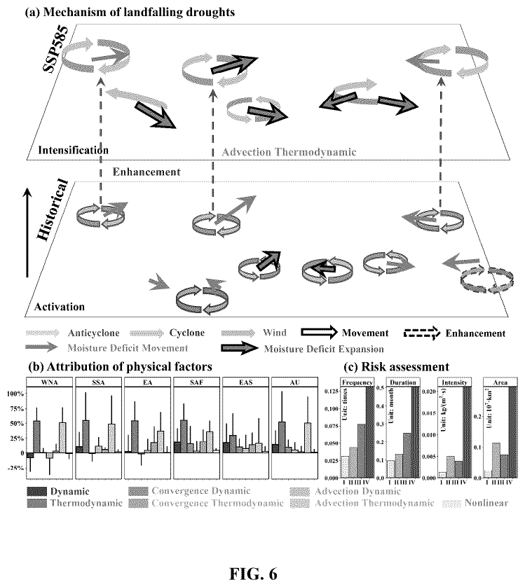

As shown in FIG. 6, in occurrence of the OTLD in each landfalling hotspot, the northern hemisphere is mainly affected by anticyclones, while the southern hemisphere is affected by anticyclones and cyclones. In intensification, three anticyclones for occurrence in the northern hemisphere are enhanced in the future, thereby intensifying the OTLD in the three landfalling hotspots. The other three landfalling hotspots have the intensified OTLD under other anticyclones and circulation. In future intensification, under global warming, the thermodynamic component (FIG. 6b) facilitates moisture transport. The advection thermodynamic component (a change in horizontal gradient of the specific humidity) plays a dominant role.

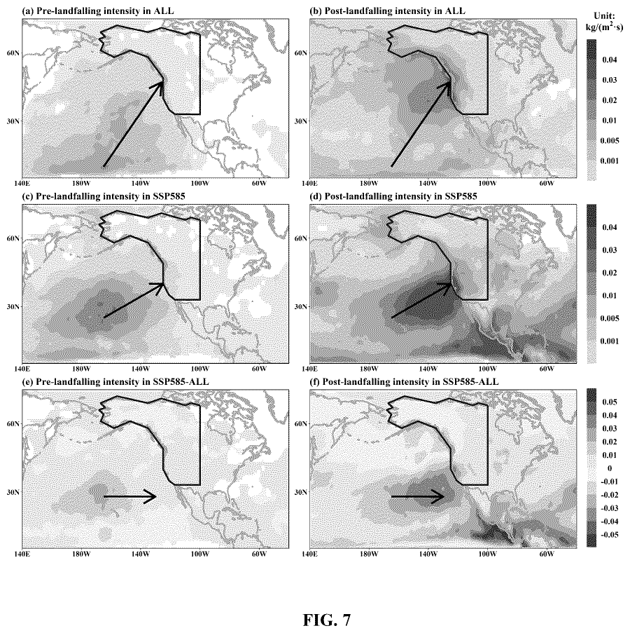

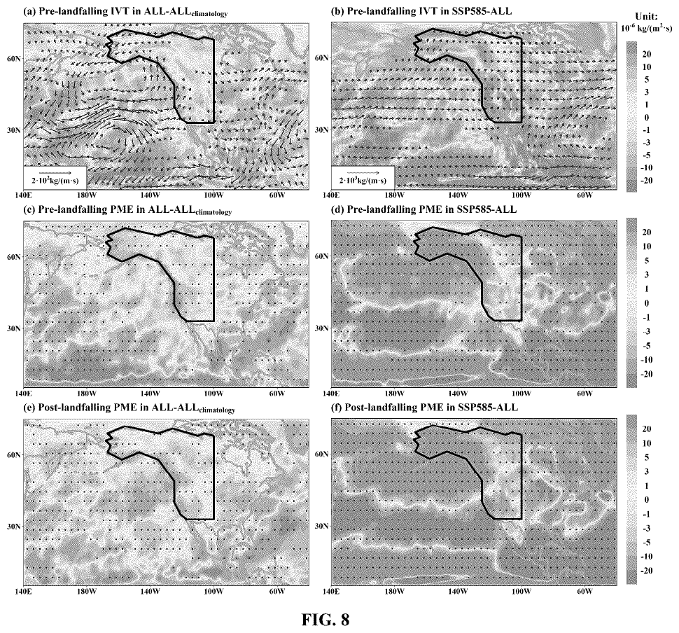

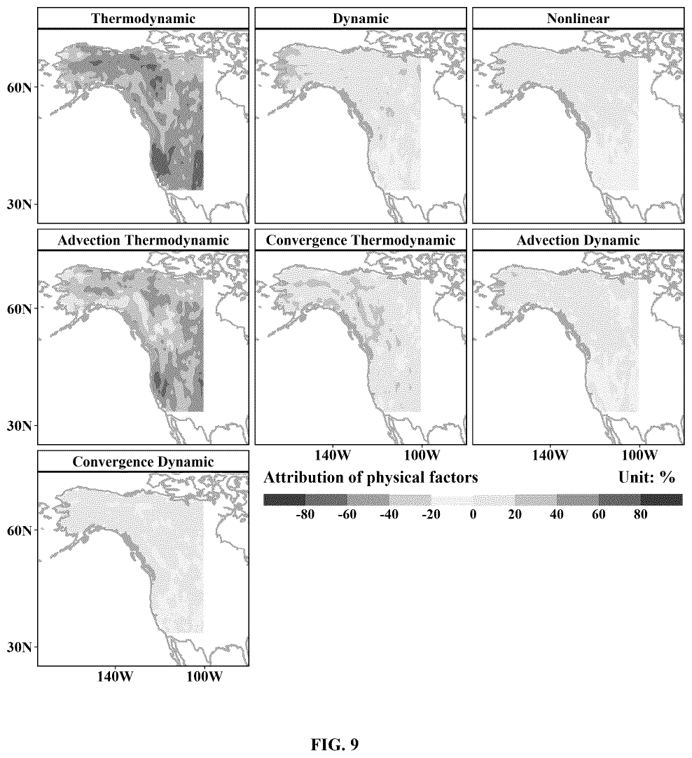

In the implementation, the occurrence mechanism and the intensification mechanism of the OTLD are analyzed specifically with the WNA as an example. As shown in FIG. 7, in the historical period, the OTLD migrated onto the WNA is mainly distributed in the low-latitude Pacific in the pre-landfalling period (FIG. 7a), anticyclones are also located in the low-latitude Pacific (FIG. 8a), and the anticyclones subsequently shift poleward and move to the west of the WNA (FIG. 3a), such that the OTLD migrated onto the WNA is spread to the west of the WNA in the post-landfalling period (FIG. 7b). In the future period, the OTLD migrated onto the WNA is mainly distributed in the middle-low-latitude Pacific in the pre-landfalling period (FIG. 7c), anticyclones are enhanced in the middle-low-latitude Pacific (FIG. 8b), and the enhanced anticyclones continuously intensify a moisture loss of the middle-low-latitude Pacific, such that the OTLD migrated onto the WNA is spread to the west of the WNA in the post-landfalling period (FIG. 7d). Compared with the intensification in the historical period, the moisture deficit anomaly continues to shift toward the WNA (FIG. 7e-f). This indicates that anthropogenic enhancement facilitates the landfalling process of the OTLD. The advection thermodynamic component plays a dominant role (FIG. 9). To verify a reasonability of the moisture transport condition for analyzing the OTLD, a moisture flux divergence in calculation of a moisture output condition is replaced by the PME to obtain FIG. 8c-f The same spatial distribution shows that the moisture transport condition is reasonable for analyzing the OTLD.

(6) Synthetic risk assessment of the OTLD is performed.

In the implementation, based on the grid cell index of the extreme OTLD, including the frequency, the duration, the area, and the intensity, unsupervised clustering is performed with a SOM neural network to obtain synthetic risks of different grid cells. There are four risk levels. In the implementation, data to be trained in the SOM neural network is an anomaly percent of an average grid cell index of the extreme OTLD in the assemble in the historical forcing test and the future SSP scenario test. As shown in FIG. 6a, in the historical period, the six landfalling hotspots are located in a high-risk region of the OTLD. In the future period, the six landfalling hotspots have an increasingly intensified synthetic risk (FIG. 6c). This indicates that the anthropogenic impacts intensify the high risk of the extreme OTLD in the landfalling hotspots.

The present disclosure has following beneficial effects:

(1) The present disclosure provides the OTLD identification method to facilitate better understanding of academic circles on the new type of droughts. The present disclosure quantifies an event index and a spatial grid mapping index of the OTLD, and clarifies changes and impacts of the OTLD in time and space. The present disclosure conducts synthetic risk assessment on OTLD-affected regions with a machine learning method, and classifies different risk levels for different OTLD-affected regions, thereby providing scientific bases for drought control policies and measures.

(2) The present disclosure performs quantitative detection on the index of the OTLD, identifies anthropogenic impacts on the OTLD in different regions, and predicts a future change of the OTLD. This provides a theoretical support for decision makers to formulate climate change adapting and relieving decisions on the OTLD.

(3) The present disclosure analyzes moisture transport conditions of the OTLD, and clarifies a physical mechanism for generating the OTLD in a historical period and a physical mechanism for enhancing the OTLD in a future period in different regions. Based on quantization of the physical moisture transport process, the present disclosure clarifies a primary physical factor in the future OTLD intensification from a dynamic factor and a thermodynamic factor. This provides a theoretical support for attribution of the OTLD.

The above are merely preferred examples of the present disclosure, and are not intended to limit the present disclosure. Any modifications, equivalent replacements, improvements, and the like made within the spirit and principle of the present disclosure shall be all included in the protection scope of the present disclosure.

1. An ocean-onto-land drought (OTLD) identification and propagation mechanism analysis method, comprising the following steps:
step S1, data acquisition: acquiring data comprising precipitation, evapotranspiration, a meridional wind velocity, a zonal wind velocity, a specific humidity, and a surface air pressure in a Coupled Model Intercomparison Project Phase 6 (CMIP6); and acquiring a mask file for global land;
step S2, OTLD identification: calculating, with a kernel density estimate, the data in the step S1, and a precipitation-minus-evapotranspiration (PME), a drought index for characterizing an atmospheric drought, setting a drought threshold to divide a grid cell in a drought state, obtaining a space-time cube (STC) of the drought through three-dimensional (3D) spatiotemporal clustering, setting a drought landfalling area threshold, and extracting an STC of an OTLD in combination with the mask file in the step S1;
step S3, OTLD spatiotemporal characteristic quantification: calculating a temporal characteristic, a spatial characteristic and an intensity characteristic of the OTLD in combination with the STC of the OTLD in the step S2, and mapping the temporal characteristic, the spatial characteristic and the intensity characteristic to a spatial grid cell to obtain a grid cell index;
wherein the step S3 specifically comprises:
S31, respectively defining the temporal characteristic, the spatial characteristic and the intensity characteristic of the OTLD as a duration, a maximum area, and an intensity and a synthetic index, wherein the duration refers to lifetime of the OTLD, the maximum area refers to a total area of spatial grid cells affected by the OTLD, and the intensity refers to a sum of a PME corresponding to each grid cell in the 3D STC of the OTLD, specifically:
$$Synthetic index = {\sum }_{t ∈ T} {\sum }_{i ∈ {A}_{t}} \frac{{PME}_{i , t} \times {S}_{i}}{{\sum }_{i ∈ A} {S}_{i}}$$
wherein, t is month, T is a time range, i is the grid cell, A is a spatial range of the drought in the timestep, PME is the precipitation-minus-evapotranspiration, and S is an area of the grid cell; and
S32, quantifying the spatially mapped grid cell index of the OTLD as a frequency, the duration, an area, the intensity, and the synthetic index, specifically:
$${Frequency}_{k} = {\sum }_{j ∈ N} 1 ,$$
$${Duration}_{k} = {\sum }_{j ∈ N} {\sum }_{{t}_{j} ∈ {T}_{j}} 1 ,$$
$${Area}_{k} = {\sum }_{j ∈ N} {\sum }_{{t}_{j} ∈ {T}_{j}} {\sum }_{{i}_{j , t} ∈ {A}_{j , t}} {S}_{i}$$
$${Intensity}_{k} = {\sum }_{j ∈ N} {\sum }_{{t}_{j} ∈ {T}_{j}} {\sum }_{{i}_{j , t} ∈ {A}_{j , t}} {PME}_{i , t} ,$$
$$Synthetic {index}_{k} = {\sum }_{j ∈ N} {\sum }_{{t}_{j} ∈ {T}_{j}} {\sum }_{{i}_{j , t} ∈ {A}_{j , t}} synthetic {index}_{i , t}$$
wherein, k is the corresponding grid cell, t is the month, T is the time range, j is the OTLD, N is an OTLD assemble, i is the grid cell of the OTLD, A is the spatial range of the drought in the timestep, PME is the precipitation-minus-evapotranspiration, and S is the area of the grid cell;
step S4, OTLD index detection and attribution: dividing spatiotemporal characteristics of the OTLD in the step S3 into an event index and the grid cell index, performing detection and attribution on an event index and a grid cell index of the OTLD in a historical forcing test and a natural forcing test, and performing detection and attribution on a grid cell index of the OTLD in the historical forcing test and a future shared socio-economic pathway (SSP) scenario test;
wherein the step S4 specifically comprises:
S41, identifying a landfalling hotspot, selecting an extreme OTLD in each pattern of the historical forcing test and the natural forcing test, calculating a landfalling frequency of the extreme OTLD in each pattern in the spatial grid cell, and dividing a landfalling-prone region;
S42, performing detection and attribution on the event index of the OTLD, synthesizing four event indexes of the extreme OTLD in each pattern into an event index sequence, performing a Kolmogorov-Smirnov (K-S) test, and clarifying a distribution difference in the event index sequence of the OTLD between the two tests;
S43, performing detection and attribution on the grid cell index mapped by the OTLD, accumulating five grid cell indexes of the extreme OTLD in each pattern in time scale, dividing a number of years in a whole time period to obtain an annual average grid cell index of the OTLD, and defining a ratio of a difference between an annual average grid cell index in the historical forcing test and an annual average grid cell index in the natural forcing test to the annual average grid cell index in the historical forcing test as an anomaly percent for the grid cell index of the OTLD in the historical period and the future period; and
S44, selecting a spatial grid cell in the landfalling-prone region, and performing area-weighted averaging, calculating a relative anthropogenic index (RAI) in each pattern, and performing sampling with a bootstrapping method to calculate 95% confidence intervals (CIs), thereby detecting an anthropogenic signal;
step S5, analysis of an occurrence mechanism in a historical period and an intensification mechanism in a future period for the OTLD: establishing a physical moisture transport model in combination with the 3D STC of the OTLD in the step 3, analyzing a moisture transport condition in a pre-landfalling period and a moisture transport condition in a post-landfalling period, analyzing the occurrence mechanism and the intensification mechanism of the OTLD, and acquiring a primary physical factor of the OTLD;
wherein the step S5 specifically comprises:
S51, establishing the physical moisture transport model in combination with an initial dataset, and analyzing the moisture transport condition in the pre-landfalling period and the moisture transport condition in the post-landfalling period, wherein
the physical moisture transport model is established by:
$$\vec{Q} = \frac{1}{g} \vec{V} q$$
$$∇ \cdot \vec{Q} = ∇ \cdot ( \frac{1}{g} \vec{V} q ) = \frac{\partial }{\partial x} ( \frac{1}{g} uq ) + \frac{\partial }{\partial y} ( \frac{1}{g} vq )$$
wherein, \vec{V} is (u v), u is zonal wind, v is meridional wind, g is a specific humidity, \vec{Q} is a moisture flux, x and y are respectively a meridional distance and a zonal distance, ∇ is a divergence operator, and g is a gravitational acceleration; and
analyzing, with the moisture transport condition in the pre-landfalling period and the moisture transport condition in the post-landfalling period, the occurrence mechanism and the intensification mechanism of the OTLD; and
S52: performing multidimensional construction on a physical model from a physical factor, and decomposing the physical factor:
$$δ ( {\int }_{pt}^{ps} ∇ \cdot ( \overline{q} \overline{\vec{V}} ) dp ) = {\int }_{pt}^{ps} {\overline{\vec{V}}}_{c} ∇ {\overline{q}}_{a} dp + {\int }_{pt}^{ps} {\overline{q}}_{a} ∇ \cdot {\overline{\vec{V}}}_{c} dp + {\int }_{pt}^{ps} {\overline{\vec{V}}}_{a} ∇ {\overline{q}}_{c} dp + {\int }_{pt}^{ps} {\overline{q}}_{c} ∇ \cdot {\overline{\vec{V}}}_{a} dp + {\int }_{pt}^{ps} ∇ \cdot ( {\overline{q}}_{a} {\overline{\vec{V}}}_{a} ) dp$$
wherein, q̅ and \overline{\vec{V}} respectively represent a monthly average specific humidity and a monthly average wind velocity, q̅_{c} and \overline{\vec{V}}_{c} are respectively a specific humidity and a wind velocity in a reference period of the historical forcing test, q̅ₐ and \overline{\vec{V}}ₐ respectively represent a difference of an average specific humidity and a difference of an average wind velocity in a pre-landfalling/a post-landfalling period of the OTLD in the historical forcing test as compared to the reference period of the historical forcing test, ps is a surface air pressure, pt is a pressure at a top of an atmosphere, δ is a deviation operator, ∇ is the divergence operator, d is an integral element, and p is an atmospheric pressure; and
step S6, OTLD synthetic risk assessment: performing risk assessment on an OTLD-affected land region in combination with the grid cell index of the OTLD in the step S3, and a neural network model.

2. The OTLD identification and propagation mechanism analysis method according to claim 1, wherein the step S2 specifically comprises:
S21, calculating, with a PME of each pattern in the historical forcing test, the natural forcing test and the future SSP scenario test, the drought index through the kernel density estimate, specifically:
SPMEIₜ=\hat{F}(PMEₜ)
wherein, SPMEI is the drought index, t is a month, \hat{F} is an empirical distribution function obtained through the kernel density estimate, and PME is the precipitation-minus-evapotranspiration;
S22, performing two-dimensional (2D) median filtering on spatial grid data of the drought at each timestep, performing threshold division, setting a drought threshold, and converting the spatial grid data into binary grid data of 1 and 0, wherein 1 represents a drought, and 0 represents a non-drought;
S23, identifying the 3D STC of the drought with the 3D spatiotemporal clustering algorithm, wherein in the 3D spatiotemporal clustering algorithm, at each timestep, all cells of 1 and adjacent cells of 1 are merged into one drought event, and in timesteps of continuous drought events, a minimum overlapping area is set, and adjacent time events with an overlapping area beyond a threshold are merged into one 3D event; and
S24, setting a minimum landfalling area with the land mask file in the step S1, and identifying a 3D drought event originated from ocean with a landfalling area beyond a threshold as the OTLD.

3. (canceled)

4. (canceled)

5. (canceled)

6. The OTLD identification and propagation mechanism analysis method according to claim 1, wherein in the step S6, based on the grid cell index of the extreme OTLD in each pattern, namely, the frequency, the duration, the area, and the intensity, unsupervised clustering is performed with a self-organizing map (SOM) neural network to obtain synthetic risks of different grid cells.

7. An ocean-onto-land drought (OTLD) identification and propagation mechanism analysis system, comprising:
an acquisition unit configured to acquire data comprising precipitation, evapotranspiration, meridional wind velocity, zonal wind velocity, specific humidity, and surface air pressure in the Coupled Model Intercomparison Project Phase 6 (CMIP6); and acquire a mask file for global land;
a drought identification unit configured to calculate, with a kernel density estimate, the data obtained by the acquisition unit, and a precipitation-minus-evapotranspiration (PME), a drought index for characterizing an atmospheric drought, set a drought threshold to divide a grid cell in a drought state, obtain a space-time cube (STC) of the drought through three-dimensional (3D) spatiotemporal clustering, set a drought landfalling area threshold, and extract an STC of the OTLD in combination with the mask file obtained by the acquisition unit;
an OTLD spatiotemporal characteristic quantification unit configured to calculate a temporal characteristic, a spatial characteristic and an intensity characteristic of the OTLD in combination with the STC of the OTLD obtained by the drought identification unit, and map the temporal characteristic, the spatial characteristic and the intensity characteristic to a spatial grid cell to obtain a grid cell index;
the OTLD spatiotemporal characteristic quantification unit is processed as follows:
respectively defining the temporal characteristic, the spatial characteristic and the intensity characteristic of the OTLD as a duration, a maximum area, and an intensity and a synthetic index, wherein the duration refers to lifetime of the OTLD, the maximum area refers to a total area of spatial grid cells affected by the OTLD, and the intensity refers to a sum of a PME corresponding to each grid cell in the 3D STC of the OTLD, specifically:
$$Synthetic index = {\sum }_{t ∈ T} {\sum }_{i ∈ {A}_{t}} \frac{{PME}_{i , t} \times {S}_{i}}{{\sum }_{i ∈ A} {S}_{i}}$$
wherein, t is month, T is a time range, i is the grid cell, A is a spatial range of the drought in the timestep, PME is the precipitation-minus-evapotranspiration, and S is an area of the grid cell; and
quantifying the spatially mapped grid cell index of the OTLD as a frequency, the duration, an area, the intensity, and the synthetic index, specifically:
$${Frequency}_{k} = {\sum }_{j ∈ N} 1 ,$$
$${Duration}_{k} = {\sum }_{j ∈ N} {\sum }_{{t}_{j} ∈ {T}_{j}} 1 ,$$
$${Area}_{k} = {\sum }_{j ∈ N} {\sum }_{{t}_{j} ∈ {T}_{j}} {\sum }_{{i}_{j , t} ∈ {A}_{j , t}} {S}_{i}$$
$${Intensity}_{k} = {\sum }_{j ∈ N} {\sum }_{{t}_{j} ∈ {T}_{j}} {\sum }_{{i}_{j , t} ∈ {A}_{j , t}} {PME}_{i , t} ,$$
$$Synthetic {index}_{k} = {\sum }_{j ∈ N} {\sum }_{{t}_{j} ∈ {T}_{j}} {\sum }_{{i}_{j , t} ∈ {A}_{j , t}} synthetic {index}_{i , t}$$
wherein, k is the corresponding grid cell, t is the month, T is the time range, j is the OTLD, N is an OTLD assemble, i is the grid cell of the OTLD, A is the spatial range of the drought in the timestep, PME is the precipitation-minus-evapotranspiration, and S is the area of the grid cell;
an OTLD index detection and attribution unit configured to divide spatiotemporal characteristics of the OTLD obtained by the OTLD spatiotemporal characteristic quantification unit into an event index and the grid cell index, perform detection and attribution on an event index and a grid cell index of the OTLD in a historical forcing test and a natural forcing test, and perform detection and attribution on a grid cell index of the OTLD in the historical forcing test and a future shared socio-economic pathway (SSP) scenario test;
the OTLD index detection and attribution unit is processed as follows:
identifying a landfalling hotspot, selecting an extreme OTLD in each pattern of the historical forcing test and the natural forcing test, calculating a landfalling frequency of the extreme OTLD in each pattern in the spatial grid cell, and dividing a landfalling-prone region;
performing detection and attribution on the event index of the OTLD, synthesizing four event indexes of the extreme OTLD in each pattern into an event index sequence, performing a Kolmogorov-Smirnov (K-S) test, and clarifying a distribution difference in the event index sequence of the OTLD between the two tests;
performing detection and attribution on the grid cell index mapped by the OTLD, accumulating five grid cell indexes of the extreme OTLD in each pattern in time scale, dividing a number of years in a whole time period to obtain an annual average grid cell index of the OTLD, and defining a ratio of a difference between an annual average grid cell index in the historical forcing test and an annual average grid cell index in the natural forcing test to the annual average grid cell index in the historical forcing test as an anomaly percent for the grid cell index of the OTLD in the historical period and the future period; and
selecting a spatial grid cell in the landfalling-prone region, and performing area-weighted averaging, calculating a relative anthropogenic index (RAI) in each pattern, and performing sampling with a bootstrapping method to calculate 95% confidence intervals (CIs), thereby detecting an anthropogenic signal;
a unit for analyzing an occurrence mechanism in a historical period and an intensification mechanism in a future period for the OTLD, configured to establish a physical moisture transport model in combination with the 3D STC of the OTLD obtained by the OTLD spatiotemporal characteristic quantification unit, analyze a moisture transport condition in a pre-landfalling period and a moisture transport condition in a post-landfalling period, analyze the occurrence mechanism and the intensification mechanism of the OTLD, and acquire a primary physical factor of the OTLD; and
the a unit for analyzing an occurrence mechanism in a historical period and an intensification mechanism in a future period for the OTLD is processed as follows:
establishing the physical moisture transport model in combination with an initial dataset, and analyzing the moisture transport condition in the pre-landfalling period and the moisture transport condition in the post-landfalling period, wherein
the physical moisture transport model is established by:
$$\vec{Q} = \frac{1}{g} \vec{V} q$$
$$∇ \cdot \vec{Q} = ∇ \cdot ( \frac{1}{g} \vec{V} q ) = \frac{\partial }{\partial x} ( \frac{1}{g} uq ) + \frac{\partial }{\partial y} ( \frac{1}{g} vq )$$
wherein, \vec{V} is (u v), u is zonal wind, v is meridional wind, g is a specific humidity, \vec{Q} is a moisture flux, x and y are respectively a meridional distance and a zonal distance, ∇ is a divergence operator, and g is a gravitational acceleration; and
analyzing, with the moisture transport condition in the pre-landfalling period and the moisture transport condition in the post-landfalling period, the occurrence mechanism and the intensification mechanism of the OTLD; and
performing multidimensional construction on a physical model from a physical factor, and decomposing the physical factor:
$$δ ( {\int }_{pt}^{ps} ∇ \cdot ( \overline{q} \overline{\vec{V}} ) dp ) = {\int }_{pt}^{ps} {\overline{\vec{V}}}_{c} ∇ {\overline{q}}_{a} dp + {\int }_{pt}^{ps} {\overline{q}}_{a} ∇ \cdot {\overline{\vec{V}}}_{c} dp + {\int }_{pt}^{ps} {\overline{\vec{V}}}_{a} ∇ {\overline{q}}_{c} dp + {\int }_{pt}^{ps} {\overline{q}}_{c} ∇ \cdot {\overline{\vec{V}}}_{a} dp + {\int }_{pt}^{ps} ∇ \cdot ( {\overline{q}}_{a} {\overline{\vec{V}}}_{a} ) dp$$
wherein, \vec{q} and \overline{\vec{V}} respectively represent a monthly average specific humidity and a monthly average wind velocity, q̅_{c}, and \overline{\vec{V}}_{c} are respectively a specific humidity and a wind velocity in a reference period of the historical forcing test, q̅ₐ and \overline{\vec{V}}ₐ respectively represent a difference of an average specific humidity and a difference of an average wind velocity in a pre-landfalling/a post-landfalling period of the OTLD in the historical forcing test as compared to the reference period of the historical forcing test, ps is a surface air pressure, pt is a pressure at a top of an atmosphere, δ is a deviation operator, ∇ is the divergence operator, d is an integral element, and p is an atmospheric pressure;
an OTLD synthetic risk assessment unit configured to perform risk assessment on an OTLD-affected land region in combination with the grid cell index of the OTLD obtained by the OTLD spatiotemporal characteristic quantification unit, and a neural network model.
